(19) United States
(12) Patent Application Publication
(10) Pub. No.: US 2021/0320959 A1
(43) Pub. Date: Oct. 14, 2021

(54) SYSTEM AND METHOD FOR REAL-TIME MASSIVE MULTIPLAYER ONLINE INTERACTION ON REMOTE EVENTS

(71) Applicant: VICTORYREFERENCE, UNIPESSOAL, LDA., Lisbon (PT)

(72) Inventors: António DA NÓBREGA DE SOUSA DA CÂMARA, Lisbon (PT); Edmundo Manuel Nabais NOBRE, Lisbon (PT); Nuno Ricardo Sequeira CARDOSO, Lisbon (PT)

(21) Appl. No.: 17/229,286

(22) Filed: Apr. 13, 2021

Related U.S. Application Data
(60) Provisional application No. 63/009,087, filed on Apr. 13, 2020.

(51) Int. Cl. H04L 29/06; G10L 25/51; H04S 3/00

(52) U.S. Cl. CPC H04L 65/605; H04L 65/403; G10L 25/51; H04S 2400/13; H04S 3/008; H04S 2400/01; H04S 3/002

(57) ABSTRACT

The present invention discloses a system to achieve a massive multiplayer online real-time interaction, where the sound that is projected into a public arena, through the local multimedia system, will be the composition of all the sound contributions send by each remote user that are participating in the event and that will get the return feedback through the event broadcast.

### CROSS-REFERENCE TO RELATED APPLICATIONS

The present patent application incorporates by reference for all purposes the provisional U.S. patent application 63/009,087 filed on Apr. 13, 2020.

### BACKGROUND OF THE INVENTION

Presence refers to the sense of “being there”. It may apply to real world events but also media environments. “Being there” may use non-immersive or immersive telepresence methods.

Non-immersive approaches rely on the use of image and/or audio sensors and emitters “there” and in our actual physical location. Immersive approaches involve being perceptually and psychologically “submerged” in a mediated environment (Lombard & Ditto, 1997).

Non-immersive methods have been applied in interactive broadcasted events and gaming. Cheung and Karam (2013) present such methods focusing on the architecture necessary for remote participants to interact via images, sound and text in multi-media events. Lam (2007) adds features required for gaming (and gambling) environments. Watterson (2016) shows how to achieve remote interaction with broadcasted images using exercise machines. Monache et. al. (2019) presents the challenges regarding network latencies in remote music interaction that apply as well in remote interaction with broadcasted events.

Immersive methods in telepresence have been associated with the use of virtual reality approaches (Steuer, 1995). They are now commonly used in video-gaming (Hamilton, 2019).

The current non-provisional patent application introduces two new telepresence concepts: Global Stadium, based on audio; and Real Sim, the introduction and control of virtual characters in real scenes. They can have non-immersive and immersive versions (by using head mounted displays).

Global Stadium is a novel telepresence application via fusion of collective audio contributions into a projected spatialized sound in a remote location or media environment. However, it follows a sequence of known operations including audio feedback using the broadcast. It also incorporates the verification of users' location, first introduced by Paravia and Merati (2003).

### BRIEF SUMMARY OF THE INVENTION

Remote viewers can share the pleasure of an event (sports, music, or any other kind of event) as if they were on the stadium or arena. They can get real physical sensations as the ones arising in the real stadium and have the feeling of being entrained (or synchronized) with other viewers. Sound is the most appropriate sense to obtain this effect. It is also almost infinitely scalable: one just needs to add multiple sound waves produced by spectators.

The user App is the key element of the Global Stadium system. Each fan that stays at home viewing the game on the television or other digital device will have the option to be part of the event and make his voice present in the field. The app will allow users to select and send “emotions” (sounds) associated to the most common actions a normal spectator do. Those sounds include individual interactions (ex: “booooos” and cheers, goal screams, applause, and protests), instruments (whistle, horns, vuvuzela), fans' songs, or even the clubs and national anthem.

The system will use pre-recorded sounds stored on the central server. Through a dedicated app, remote users send the order associated to the sound they want to “scream” to the event, and the server will oversee their composition in a coherent sound. To ensure that the final composition of the sounds is as natural as possible, for each type of sound, the server will have a set of variants.

This strategy (using pre-recorded sounds) addresses the synchronism and latency issues inherent to real-time sound streaming (critical for massive remote user's participation events) since the information sent by each user will be minimal. Examples of this information includes (but not limited to): his ID (unique identifier); his relative geographical position (chosen via the connection's IP—Internet Protocol); the identification of the club he/she is cheering for; the code of the sound sent; and some other relevant information like voting. This system also avoids the need for real-time recognition and filtering of less suitable words, inevitable in direct streaming systems.

The adoption of emerging communication technologies, such as 5G, will solve part of the synchronization and latency problems related to real-time sound streaming strategy and will pave the way for other possibilities, namely the inclusion of remote visual interaction systems.

Knowing the relative position of each participant around the globe and the club for which he is pushing, will be possible to generate other compelling information like visual distribution maps, statistics, or even dedicated sound streaming for each club. Indeed, having the identification of the club each user is pushing for, the server can compose two (or more) sound streams, one for each team. Depending on the sound infrastructure in the stadium, it will be possible to spatialize the sound, distributing each stream accordingly with the position of the teams in the field. The visual information, in an aggregated or real-time format, can be displayed both in the app or in arenas multimedia system (screens).

To make the system even more engaging, artificial intelligence (AI) will be used to automatically recognize and send the user input without the need to even touch the smartphone screen. The user is watching the event, screaming for his/her team and, each time the system detects one of the pre-defined sounds, it will automatically send the correspondent order to the central server to play that sound. This way, it will be as if the user were screaming, not to his television, but to the arena field. This option requires the user authorization to activate (in the app settings) and use the automatic voice recognition.

Regarding the distribution of the sound in the arenas, a complementary portable sound system will be considered. This system, together with the existing sound system, will allow an optimization of the sound distribution and even its spatialization.

To manage the calendar of available games and sports in the system, a Back office with an on-line frontend will be also available.

### BRIEF DESCRIPTION OF THE DRAWINGS

FIG. 1. Illustration of the Global Stadium system.

FIG. 2. Global Stadium communications & server architecture.

FIG. 3. Global Stadium sound management system.

FIG. 4. Schematic representation of multimedia stimulus (image and sound) to local player generated by remote participants.

### DETAILED DESCRIPTION OF THE INVENTION

In this section, the Global Stadium system will be described. Global Stadium can be applied to any event with remote audiences including, but not limited to, sports events, music concerts, conferences and presentations, reality shows, TV shows, debates. Although the system can be applied to any kind of public or private event, a football game will be used to illustrate the concept.

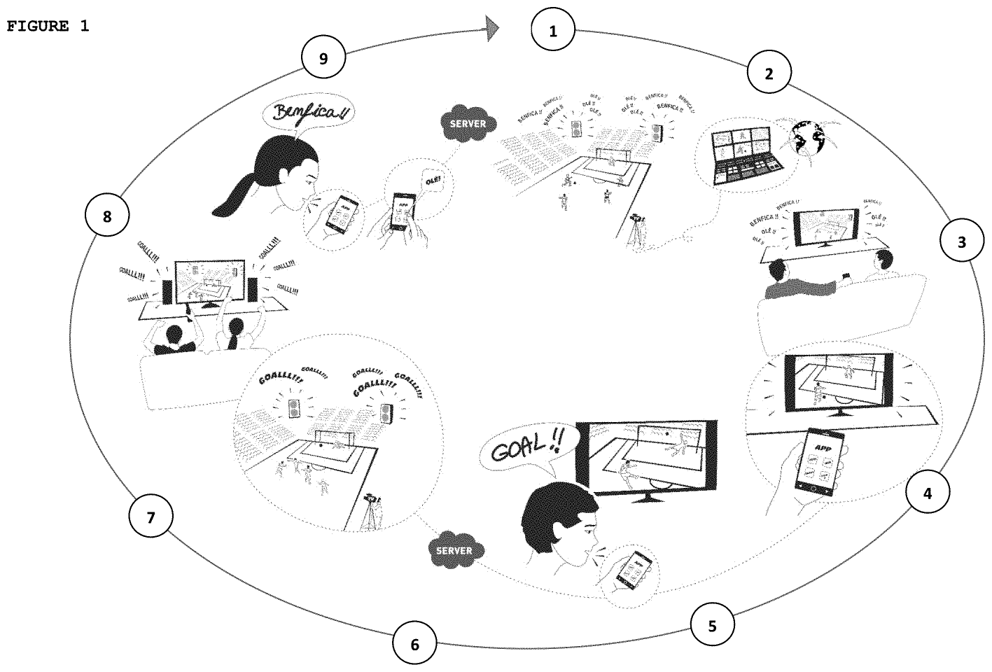

FIG. 1 represent a schematic flow of the system dynamics and will be used to illustrate the following description.

In a normal sports event, like a football game (1), the signal is captured and transmitted via TV, cable signal or other network to everyone's screens (television, computer, smartphone) (2). If you are in a remote place, like your home (3), you may want to find a way to participate as an active spectator and not only as a data (image/sound) receptor.

Global Stadium platform provides you an app (4) that will allow you to be an active participator in the event as if you were there. Using this app, you can send your emotions to the field. Just press a button representing the emotion you want to transmit to the field (or scream it—the app will recognize the sound/emotion and will send it for you) (5).

All the sounds/emotions from all the users that are using the Global Stadium system will be sent to a local server (6) that will aggregate them in a crowd sound. The resulting sound will be streamed to the field through the arena sound system making the remote users voice be present on the stadium so the players and the other local spectators can hear you too (7). Statistics from this remote interaction can be displayed in the arena screams (mainly the big screens).

Because the game is being transmitted in real time, the sounds that are generated by the remote users and played through the arena sound system will be captured and transmitted to, so the remote spectators will also hear their aggregated contribution to the global emotion (8). This will encourage them to keep participating sending more emotions to the field (9).

Implementation

System architecture. The Global Stadium system comprises the following main components: Local Server (Edge Computing System); The Client (User's App); Back Office (Cloud Server); Front-Office (Web Based); External Multimedia (Sound & image) System.

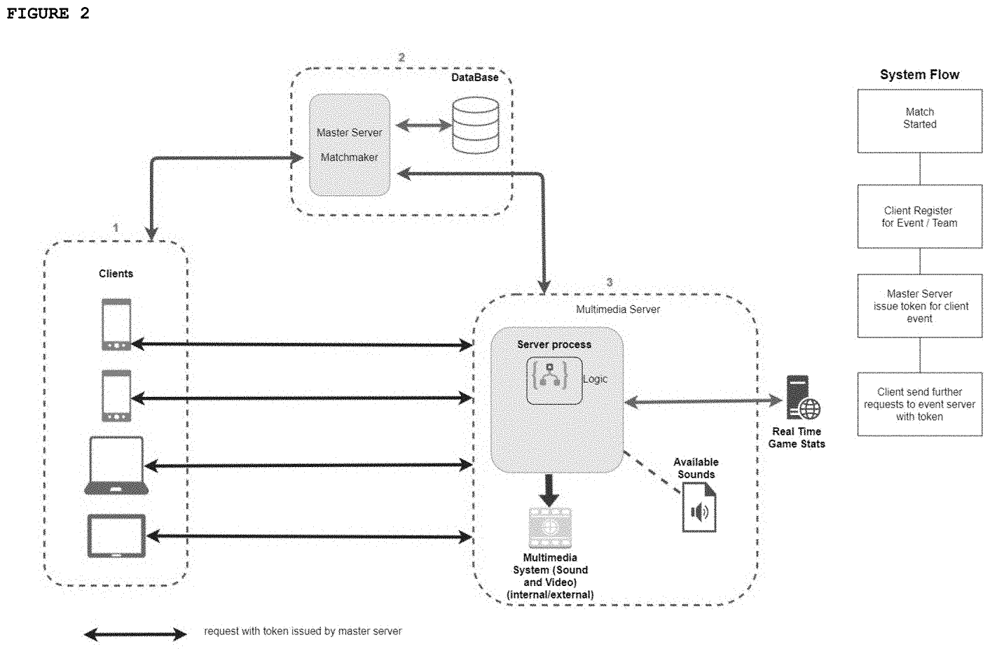

FIG. 2 represent a schematic flow regarding the system architecture, communications, and scalability. The numbers referred in this section are related to this figure (FIG. 2).

Client (1) app's register to the corresponding game on the master server (2). The Back Office is a management point of the main server, which has the responsibility for managing and configuring the multimedia servers, which communicate with the database. Optionally, the Front Office can be located on a different server, but ideally will be located also on the Master Server due to infrastructure simplification. All the information regarding the events and where those events are located, is placed on the corresponding Databases. The Front Office is web based and can be created using any popular library designed to build user interfaces with database integration. After the initial synchronization, the app will know how to communicate with the specific multimedia server. A validated payload is returned to the client, and with that payload, which is signed by the master server (for security reasons) the connection will be established with the multimedia server (3) on game location (corresponding node). The direct connection over the most appropriate protocol is full duplex. Clients issue commands that are validated by the server (3).

Communications

The mobile app or website, on start, will check all events on the Back Office and download all the necessary information to be able to connect to the corresponding server, located at each event. The server connection between the client (mobile app or website) is established trough WebSocket after team selection. This connection will be used between server/client and to keep all the necessary information updated.

All sound requests will be sent through secured requests, using the appropriated protocol. Those requests will be received through our API and transferred to the server. The server knows, in real time, all the relevant game statistics to validate, for example, the goal sound. Others sound types, like the ones from supporting fans, will be filtered through a filter (algorithm) which will calculate the “weight” of the requests and will output the respective sound in terms of volume and duration.

The sounds are predefined and are placed, locally, on the server. In each location the server will be an Edge Computing system. The characteristics of the Edge Computing System must be considered in function of the specific demands of each place. It must be a system powerful enough to be able to cope with all requests with minimal delay. This must be calculated considering the expected simultaneous user count.

The API Gateway, Back Office and database, ideally, will be placed on Dedicated VPS or Cloud services so it can be easily accessible from anywhere and to free local servers from that task. This will free the local servers load and network to optimize the requests between the app and those servers and will centralize the access point for multi-event management situations (ex: manage all the games in each country football league).

Local Server (Edge Computing System)

Edge computing is a distributed computing system with the objective of bringing computation and data storage closer to the location where it is needed to improve response times and save bandwidth. Edge computing will optimize the Global Stadium app by bringing computing closer to the source of the data. This minimizes the need for long distance communications, which reduces latency and bandwidth usage.

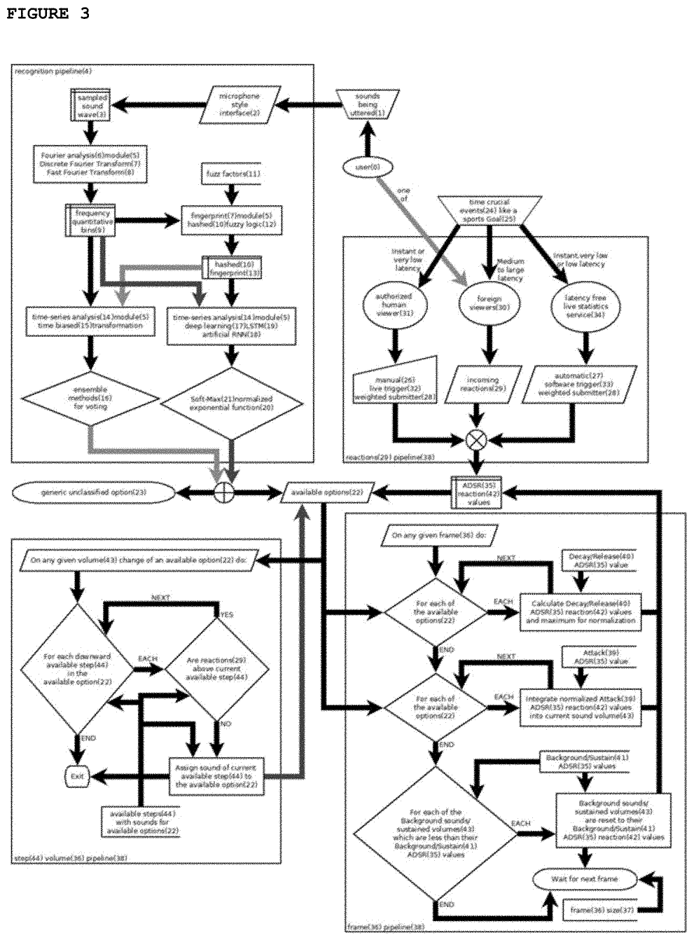

Sound Composition (on the Local Server Side) (the Numbers Referred in this Section are Related to FIG. 3)

This describes a method using an Attack/Decay/Sustain/Release (ADSR) (35) scheme to mix sounds from a set of available options (22) giving each a volume that combines the weighted amount of each individual reaction (42) from incoming reactions (29) from foreign viewers (30) and, for time crucial events (24), a possible amount from a manual (26) weighted submitter (28) and a possible amount from an automatic (27) weighted submitter (28). The raw number of combined reactions (42) also selects a sound from the available steps (44) of the selected available option (22). A configurable frame (36) size (37) value defines the amount of time that exists in a processing frame (36) pipeline (38). A configurable sound Attack (39) ADSR (35) value defines the sound attack rate in any given frame (36). A configurable sound Decay/Release (40) ADSR (35) value defines the sound decay and released percentage in any given frame (36). A configurable background Sustain (41) ADSR (35) value defines the minimum sustained background sound volume (43).

On any given frame (36) do the following: For each of the available options (22) calculate Decay/Release (40) ADSR (35) reaction (42) values and maximum for normalization; For each of the available options (22) Integrate normalized Attack (39) ADSR (35) reaction (42) values into current sound volume (43); If the background sound volume (43) falls below the configurable background Sustain (41) ADSR (35) value, Sustain (41) it; Wait for next frame.

On any given weighted submitter (28) or single reaction (42) from incoming reactions (29) do the following: Check and find reaction (42) in available options (22) and; Add single or weighted value to reaction (42) value.

Latency Issues (the Numbers Referred in this Section are Related to FIG. 3)

This describes a method to minimize the latency in reactions to specific time crucial events (24), like a sports Goal (25), from a set of available options (22). For time crucial events (24), a specific manual (26) or automatic (27) weighted submitter (28) must be provided to compensate for latency in incoming reactions (29) from foreign viewers (30). A manual (26) weighted submitter (28) can be a local authorized human viewer (31) pushing a live trigger (32). An automatic (27) weighted submitter (28) can be a software trigger (33) monitoring a latency free live statistics service (34).

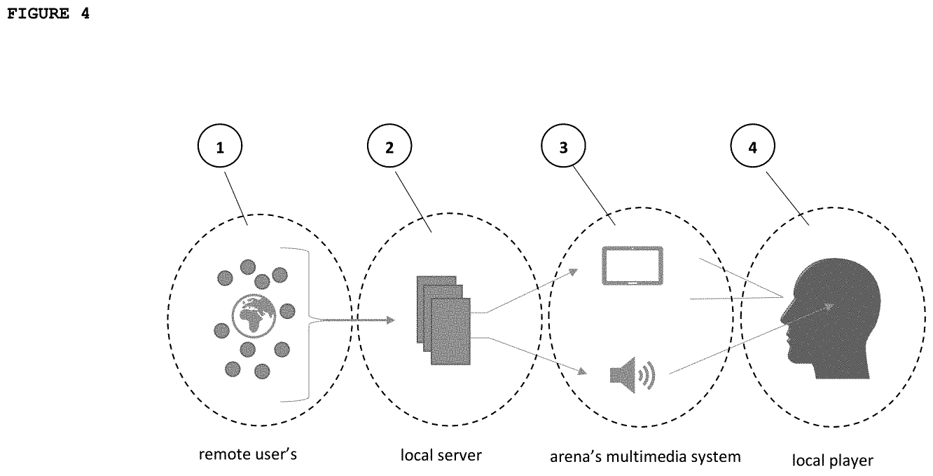

Connection to Multimedia (Sound & Image) Local Systems (The Numbers Referred in this Section are Related to FIG. 4.)

The Global Stadium local server can support 2 or more independent sound channels. If the stadium sound system also supports different channels, then it will be possible to place specific sounds on specific places at the stadium. In a stadium with a sound system that can provide independent sound channel distribution along the space, it will be possible spatialize the sound by placing different sounds in different areas of the stadium. The Global Stadium system allows generating different sound files coming from different groups of participants (ex: supporters from each one of the teams). These different sounds can be placed in different channels and, therefore, redirected to a specific channel in the stadium sound system (if the stadium sound system supports that). That way, sound can be spatialized through the stadium, where each sound is sent to different areas to simulate the supporters positioning in the stadium. The sound output from the server is done, typically, trough 3.5 mm jack plugs. However, the connections can be adapted to any sound system typically used on this type of installations. Besides the audio output injected in the arena sound system described before, the local server can also produce visual output to feed, in real-time, the screens around the arena and, particularly, the main screen that usually exists in those big public events. Once the local server (2) collects the information related with all user's actions (1) that are connected to a particular event (ex: sending sounds, voting), it will be possible to generate visual information coherent with the sound output (3). This way, for those who are in the arena (whether they are in a sports game, in a public debate or in any other event), it will be possible to hear the user's remote participation, but also to see some related visual information (4). This will make the system more engaging, compelling, and credible. Some of these visual information's can include, among others, the following items: The number of remote users that are linked and participating; A map with the spatial information of the remote participants location in a specific area (ranging from local to global, depending on the event); The identification of the sounds that are most used (instant or cumulative numbers); The volume peak; Voting results. These visual outputs can be generated in an aggregated way to be sent to a single screen (ex: the main screen on a sports arena) or decomposed and distributed to different screens.

Automatic Sound Recognition (on the App User's Side) (The Numbers Referred in this Section are Related to FIG. 3)

This describes a method to automatically classify the sounds being uttered (1) by the user (0) and check if they fall into a set of available options (22) that can be used to select and submit sound choices. Sound can be captured by a microphone style interface (2), or any other means that can produce a sampled sound wave (3). Sound can be identified by using a pipeline (4) of mandatory and optional modules (5). A first mandatory module (5) consists in a method of performing Fourier analysis (6) on the provided sampled sound wave (3) using a continuous Discrete Fourier Transform (7), like a Fast Fourier Transform (8), providing a resulting list of frequency quantitative bins (9) for further processing. A second optional module (5) can be enabled where the values in multiple relevant frequency quantitative bins (9) can be hashed (10) together, with or without fuzz factors (11) or other means of fuzzy logic (12), to provide single fingerprint (13) values for further processing. A third mandatory module (5) performs time-series analysis (14), receiving values from single instances of multiple relevant frequency quantitative bins (9) or single instances of fingerprint (13) values, using them for classifying the sampled sound wave (3) within a set of available options (22) or a generic unclassified option (23). One kind of time-series analysis (14) module (5) can use received values through time biased (15) ensemble methods (16) to vote on a set of available options (22) or a generic unclassified option (23). Another kind of time-series analysis (14) module (5) can use deep learning (17) through an artificial recurrent neural network (RNN) (18) architecture, like a Long Short-Term Memory (LSTM) (19) network, outputting the result of a normalized exponential function (20), like Soft-Max (21), producing a list of probabilities of a set of available options (22) and a generic unclassified option (23). The output of the time-series analysis (14) module (5) effectively classifies the most likely sound being uttered by the user (0) and, if it is not the generic unclassified option (23), selects and submits the highest probable member from a set of available options (22).

Engagement Strategies

Several strategies have been incorporated in the system to maximize user engagement:

Social collective behaviors strategies: In a crowd situation, social collective behaviors will emerge naturally by “osmosis” and this is one of the most attractive elements on a big event (“I'm part of something”). That is quite evident in a football game when fans start to sing theirs club support songs (even if they do not know each other's). When people are spatially spread and lose direct contact with the others, these collective behaviors may be lost. Some strategies have been implemented in the “Global Stadium” system to incentivize collective behaviors. Those strategies include: Real-time cumulative action's (sounds) activity, meaning the app will provide, in real-time, the information about how many contributions for each specific sound are active (ex: how many people are “applauding” is this moment). With that information, users can perceive if there is a behavior tendency and decide to join it (Ex: if the user realizes that there is a growing movement of people that starts to “sing” the club's song, then we may decide to join them and also “click” on that song to) and; Real-time cumulative supporter's (users) activity, oriented to collective supporters' behaviors. The app will provide a visual indicator of the cumulative activity of supporters of each team. The objective is to stimulate team supporter's competition (“whose fans support more their own team”). The expected effect is that if a user realizes that the other team supporters are more active than his/her own team supporters, he/she will start to be more active supporting his team. This effect can be magnified by creating an on-line “Top 10 best team supporters”.

Voting: Another strategy to stimulate the user's involvement and participation in the “Global Stadium” experience is to allow them to vote for specific topics. For example, in a football game, those topics could include (but not limited to): Best player on match; Worst player; Rating of the referee; Best goal in the match.

It is important to emphasize that this disclosure presents illustrative embodiments by way of representation and not limitation. Numerous other modifications and embodiments can be devised by those skilled in the art which fall within the scope and spirit of the principles of the presently disclosed embodiments.

### RELATED REFERENCES

Cheung, E., Karam, G. (2013) Methods, systems, and computer program products for providing remote participation in multi-media events, US patent 20110082008A1
Hamilton, R. (2019) Collaborative and competitive futures for virtual reality music and sound, 2019 IEEE Conference on Virtual Reality and 3D User Interfaces (VR)
Monache, S. et al. (2019) Time is not on my side: network latency, presence and performance in remote music interaction, INTERMUSIC EU project.
Lam, M. (2007) Method and system for facilitating remote participation in casino gaming activities, European patent 1816617A1
Lockton, D., Berner, M., Mitchell, M. and Lowe, D. (2012) Methodology for equalizing systemic latencies in television reception in connection with games of skill played in connection with live television programming, U.S. Pat. No. 8,149,530B1
Lombard, M., & Ditton, T. (1997) At the heart of it all: The concept of presence. Journal of Computer-Mediated Communication, 3(2), Retrieved Mar. 22, 2009 from http://jcmc.indiana.edu/vol3/issue2/lombard.html
Lopes, G. et al. (2009) Systems and methods for simulating three-dimensional virtual interactions from two-dimensional camera images, U.S. Pat. No. 8,624,962B2
Lopes, G. et al. (2010) Various methods and apparatuses for achieving augmented reality, U.S. Pat. No. 8,405,680B1
Nobre, E., Camara, A. (2001) Exploring Space Using Multiple Digital Videos, Multimedia 2001, (pp. 177-188), Springer
Paravia, J. and Merati, B., (2003) Gaming system with location verification, U.S. Pat. No. 6,508,710B1
Steuer, J. (1995). Defining virtual reality: Dimensions determining telepresence. In F. Biocca & M. R. Levy (Eds.), Communication in the age of virtual reality (pp. 33-56). Hillsdale, N.J.: LE
Watterson, E. (2016). Providing interaction with broadcasted media content, US patent 20160059079A1

1. A system for real-time massive multiplayer online interaction on remote events characterized by the fact that the system includes:
an edge computing system or local server;
a back office or cloud server;
a web based front office;
an external multimedia system including sound and image components;
an user's app or website; and
wherein
the edge computing system or local server supports two or more independent sound channels and is configured to generate visual information coherent with the sound output.

2. System, according to claim 1, characterized by the fact that a manual weighted submitter or an automatic weighted submitter is optionally present and configured to compensate for latency in reactions to specific time crucial events.

3. A method for real-time massive multiplayer online interaction on remote events characterized by using the system as defined in claim 1 and comprising the following steps:
the user registers to the remote event desired;
the sounds uttered by the user are captured by a microphone or any other means that can produce a sampled sound wave or remote users send orders to activate specific pre-recorded sounds already existing in the local server in reaction to a specific event situation;
an Attack/Decay/Sustain/Release (ADSR) scheme mixes all of the sounds related with all user's reactions and gives each sound a volume that combines the weighted amount of each individual reaction from incoming reactions from the users;
the sounds are automatically classified according to the available options; and
the sound is locally placed on different channels on the local server and spatialized through the stadium or the sound is added to the streaming transmission of the event that is being broadcasted to the public.

4. Method, according to claim 3, characterized by the fact that, the information related with all user's reactions further produces visual output coherent with the sound output to feed the screens around the arena in real-time.

5. A mobile device or computer apparatus characterized by comprising means adapted to perform one or more steps of the method defined in claim 3.

6. Computer program, characterized by comprising instructions to provide that a mobile device or a computer apparatus executes the steps of the method defined in claim 3.

7. Reading means for mobile device or computer apparatus characterized by comprising the installation of a computer program, as defined in claim 6.
